(19) United States
(12) Patent Application Publication
(10) Pub. No.: US 2014/0040476 A1
(43) Pub. Date: Feb. 6, 2014

(54) METHOD AND SYSTEM FOR NETWORK RESTRUCTURING IN MULTILAYER NETWORK

(71) Applicant: Shinya Ishida, Tokyo (JP)

(72) Inventor: Shinya Ishida, Tokyo (JP)

(73) Assignee: NEC CORPORATION, Minato-ku, Tokyo (JP)

(21) Appl. No.: 13/819,268

(22) PCT Filed: Aug. 26, 2011
(86) PCT No.: PCT/JP2011/004752

§ 371 Date: Oct. 15, 2013

(30) Foreign Application Priority Data
Aug. 26, 2010 (JP) 2010-189241

(51) Int. Cl. H04L 29/12

(52) U.S. Cl. CPC H04L 61/103
USPC 709/226

(57) ABSTRACT

In a multilayer network, flexible and cost-efficient restructuring of an upper layer network depending on a change in a network state can be achieved. Each node at each layer includes an event-operation database (305) storing event-operation correspondence information and an operation execution control section (304) that, upon occurrence of an event, refers to the event-operation correspondence information and executes a responding operation. The operation is to send a message indicating the occurrence of the event to a specified node, to set a path that bases a link in at least one upper layer network, or a combination of them. With a node (N15, N13) that has detected occurrence of a predetermined event serving as a start point, nodes sequentially specified execute operations by referring to the event-operation correspondence information stored in their own nodes, whereby the upper layer network (L204) is automatically restructured.

### TECHNICAL FIELD

The present invention relates to a multilayer network and, more particularly, to a method and system for restructuring an upper-layer network.

### BACKGROUND ART

In recent years, service providers (SP) provide services to connect a plurality of geographically apart local area networks (LAN) owned by a client and build a virtual private network (VPN). The client connects, from each LAN, to an edge node located at an end of a service provider network. Traffic entering the edge node from each LAN of the client is switched within the service provider network and delivered to a destination LAN through another edge node to which the destination LAN is connected. To the client, the service provider network works as if it is a LAN switch. Mechanisms providing such a service include, for example, VPLS (Virtual Private LAN Service), which is standardized by IETF (Internet Engineering Task Force).

To accommodate a large number of VPN services, large traffic capacity is required of a service provider network. Wavelength division multiplexing (WDM) is a general means for increasing the traffic capacity of a network. This is a technology of multiplexing a plurality of signals of different wavelengths on a single optical fiber. The transmission capacity of a single optical fiber is increased to several Tbps by application of WDM. In current predominant WDM systems, since one wavelength has a bandwidth of 10 Gbps or more, it is possible to provide a line having a bandwidth of 10 Gbps or more. Moreover, paths transmitting optical signals can be switched for each wavelength, by connecting an optical add-drop multiplexer (OADM) and/or an optical cross-connect (OXC). A WDM network in which OADM and/or OXC are implemented is called a wavelength routing network, which can provide a line (wavelength path) having the bandwidth of a wavelength even between points where a plurality of hops take place along optical fiber.

On the other hand, a bandwidth demanded by most VPN service clients is as little as approximately 100 Mbps or 1 Gbps. In addition, it is rare that as much traffic as the capacity of a line is always continuously transmitted. Accordingly, there is a large difference between the amount of traffic that a VPN service client actually sends and the bandwidth of a wavelength path. Therefore, a logical network where a wavelength path serves as a link is built, and a path with granularity finer than the bandwidth of a wavelength is set on the logical network, whereby it is possible to provide a VPN service in which a path with finer granularity serves as a virtual link. Conceivable nodes in such a logical network include switches in conformity with OTN (Optical Transport Network), SONET/SDH (Synchronous Optical Network/Synchronous Digital Hierarchy), or MPLS-TP (Multiprotocol Label Switching-Transport Profile) and routers in conformity with IP/MPLS (Internet Protocol/Multiprotocol Label Switching). It is also conceivable to build a logical network itself with a plurality of layers, by combining those nodes. As described above, a service provider network is built as a multilayer network with a plurality of layers, whereby it is possible to efficiently multiplex and accommodate VPN services.

(I) Multilayer network

FIG. 1 shows a configuration example of a multilayer network. In this example, a physical network at a lower layer is formed of nodes N1101 to N1107 and links L1101 to L1109, and on top of it built is a logical network at an upper layer that is formed of nodes N1201 to N1203 and links L1201 to L1203.

The nodes N1201, N1202 and N1203 at the upper layer are connected to the nodes N1101, N1103 and N1106 at the lower layer through links L1110, L1111 and L1112, respectively. For simplicity, each of the links L1110 to L1112 is shown by a single solid line but in some actual cases can include a plurality of links.

The link L1201 between the nodes N1201 and N1203 at the upper layer is a virtual link whose actual entity is a chain of the link L1110, a path P1101, and the link L1111. Similarly, the links L1202 and L1203 are virtual links whose actual entities are a chain of the link L1111, a path P1102, and the link L1112, and a chain of the link L1112, a path P1103, and the link 1110, respectively. As shown in the drawing, by use of the three virtual links L1201 to L1203, a VLAN service is built that provides full-mesh connections for client networks (LANs) C1101, C1102, and C1103 connected to the nodes N1201, N1202, and N1203, respectively.

There are various methods for connecting client LANs in a service provider network. In a service provider network, if client LANs belonging to a VPN are connected in a full-mesh topology as shown in FIG. 1, travel between any client LANs can be achieved with one hop. That is, traffic sent from a certain client LAN is transmitted by an edge node to which the LAN is connected, directly to an edge node to which a destination client LAN is connected. Since it does not happen that traffic is transmitted via a plurality of hops, a function of relaying traffic is unnecessary, and hence the functions of edge nodes can be simplified. However, in full-mesh connections, since the number of paths increases by the squared number of client LANs, control and management are complicated. On the other hand, if edge nodes or other nodes in a service provider network include a function of relaying traffic from a client, it is possible to connect client LANs in a mesh topology, a ring topology, or a tree topology, which have fewer links than a full-mesh topology.

Whichever network topology is used for connection, virtual links as described above are used in general in terms of cost efficiency. Of the performance of a virtual link, propagation delay and others depend greatly on a physical path along which the link actually passes. Accordingly, when building a VPN with performance required by a client (for example, reducing propagation delay) taken into consideration, there is a possibility that some of virtual links partially pass along a same physical path. Alternatively, it also can happen, depending on the topology of a network located at the lowest level of a service provider network, that virtual links pass along a same physical path. For example, to build a logical network in a full-mesh topology on a physical network as shown in FIG. 1, any two of the virtual links pass along a same link at the lower layer. In FIG. 1, the paths P1102 and P1103 corresponding to the virtual links L1202 and L1203 respectively both pass along the physical link L1107.

In a multilayer network, if a plurality of virtual links belonging to an upper layer network pass along a same physical path, a plurality of link failures will occur on the upper layer network when a failure occurs in a node or a link included in the physical path. In FIG. 1, if a failure occurs in the link L1107, the virtual links L1202 and L1203 at the upper layer are disconnected at the same time, resulting in the impaired connectivity of the VLAN linking the client networks C1101 and C1102, and C1102 and C1103.

### (II) Method for Maintaining Connectivity at Upper Layer

Various methods have been proposed for maintaining such connectivity at an upper layer. For example, in a virtual topology design method disclosed in PTL 1, even if a failure as described above occurs, a change of the route of a path at a lower layer is designed so that reliability condition is met, whereby the connectivity of an upper layer network is maintained.

In a management system for a layered network disclosed in PTL 2, a failure or the like in a lower-layer line is detected as an event, an upper layer line affected by the event is identified, and line recovery processing is performed at the upper layer.

Incidentally, a backup system route control scheme disclosed in PTL 3 also can be applied to a failure in a path at a lower layer. That is, when a failure occurs in a working path at a lower layer, communication is switched to a backup path, whereby it is also possible to maintain connectivity at an upper layer. Moreover, for a method for dynamically setting a path, for example, PTL 4 discloses a method in which an alternative path is set by generating or deleting a fixed path or a dynamic path based on information about a fault on a network.

[PTL 1]Japanese Patent Application Unexamined Publication No. 2008-211551

[PTL 2]Japanese Patent Application Unexamined Publication No. 2002-354038

[PTL 3]Japanese Patent Application Unexamined Publication No. 2008-060755

[PTL 4]Japanese Patent Application Unexamined Publication No. 2008-166942

### SUMMARY

### Technical Problem

However, in the method according to PTL 1, it is difficult to maintain connectivity when a failure other than those assumed at the time of designing a network occurs, for example, when multiple failures occur. Moreover, to recover connectivity in such a case, calculation for redesigning the network is necessary, requiring a lot of time before recovery. Furthermore, as failure patterns that can be handled increase, the number of links required also increases, resulting in declining network use efficiency. Therefore, there is a limit to the number of failure patterns assumed.

Moreover, PTL 2 is premised on a centralized control by a management system managing the entire network, and is designed to maintain connectivity by identifying an upper layer line affected by a failure in a lower layer line and performing bypass processing at the upper layer. However, since this management system is all just to perform a search for a bypass path at the upper layer, a method for recovering connectivity at the upper layer has very little flexibility. Furthermore, it is necessary to identify an affected upper layer line after a failure in a lower layer line is detected and before actual bypass processing is started, and further, if pluralities of upper layer lines are affected, the processing of searching for bypass paths itself in the bypass processing may require a large amount of time. Therefore, in the system according to PTL 2, similarly to PTL 1, an amount of time which is not negligible is consumed from detection of a failure until recovery therefrom, resulting in network use efficiency declining.

Note that it is possible to apply the method according to PTL 3 or 4 to the methods according to PTLs 1 and 2. However, recovery from a failure provided by the method according to PTL 3 is to change the route of a path between nodes sending and receiving the path, and recovery from the failure cannot be achieved if there is no route available for the path.

Moreover, in the path setting method according to PTL 4, since a node sending a path plays a major role to monitor the state of the path and make determinations for addition, deletion and switching processing, what can be performed for an event such as a failure in the network is only to set an alternative path, and therefore it is difficult to perform flexible handling to maintain the connectivity of the entire network.

Briefly speaking, the above-described methods for recovery from a failure have limitations, to recover and maintain the connectivity of an upper layer network against a failure at a lower layer in a multilayer network. One of the reasons is that although a network can be designed that can maintain the connectivity at an upper layer against failures assumed in advance, countermeasures cannot be designed that are to be taken when a failure beyond the designed network's failure resistance occurs and the connectivity at the upper layer is lost. Moreover, responding to a failure at a lower layer, communication can be switched to a backup path at the lower layer. However, from the perspective of an upper layer, that is a recovery from a failure in one link only and lacks in flexibility from the viewpoint of recovering the connectivity at the upper layer.

Accordingly, an object of the present invention is to provide a network restructuring method and system that make it possible, in a multilayer network, to restructure an upper layer network depending on a change in a network state, and to operate the multilayer network flexibly and cost-efficiently.

### Solution to Problem

A network restructuring system according to the present invention is a network restructuring system in a multilayer network including multiple layers, characterized in that each node at each layer includes: storage means that stores event-operation correspondence information indicating correspondence between an event and an operation; and operation execution control means that, upon occurrence of an event, refers to the event-operation correspondence information and executes an operation corresponding to the event, wherein the operation is at least one of sending a message indicating the occurrence of the event to a specified node, setting a path that bases a link in at least one upper layer network, and a combination thereof, and wherein with a node that has detected occurrence of a predetermined event serving as a start point, nodes sequentially specified execute operations by referring to the event-operation correspondence information stored in their own nodes, whereby the upper layer network is automatically restructured.

A network restructuring method according to the present invention is a network restructuring method in a multilayer network including multiple layers, characterized in that each node at each layer stores event-operation correspondence information indicating correspondence between an event and an operation that is at least one of sending a message indicating occurrence of the event to a specified node, setting a path that bases a link in at least one upper layer network, and a combination thereof, and upon occurrence of an event, refers to the event-operation correspondence information to execute an operation corresponding to the event that has occurred, wherein with a node that has detected occurrence of a predetermined event serving as a start point, nodes sequentially specified execute operations by referring to the event-operation correspondence information stored in their own nodes, whereby the upper layer network is automatically restructured.

A node device according to the present invention is a node device included in a multilayer network that includes multiple layers, characterized by comprising: control communication means for communicating control information with another node via a control network; link monitoring means that monitors a change in a state of a link used to transmit data; an event-operation database that stores, as the event-operation correspondence information, in a searchable manner, a combination of an event received from the another node or detected by the link monitoring means and an operation corresponding to the event; and operation execution control means that, upon occurrence of the event, refers to the event-operation correspondence information and executes the operation corresponding to the event that has occurred, wherein the operation is at least one of sending a message indicating the occurrence of the event to a specified node, setting a path that bases a link in at least one upper layer network, and a combination thereof.

A network design device according to the present invention is a network design device that designs an upper layer network of a multilayer network including multiple layers, characterized by comprising: design means that calculates operational procedures including setting a path in a lower layer network required to establish a link in the upper layer network and sending/receiving a notification message, and generates event-operation correspondence information indicating correspondence between an event and an operation for each of nodes involved in the procedures; and control communication means for sending the event-operation correspondence information to each relevant node, wherein the operation is at least one of sending a message indicating occurrence of an event to a specified node, setting a path that bases a link in at least one upper layer network, and a combination thereof, and wherein with a node that has detected occurrence of a predetermined event serving as a start point, nodes sequentially specified execute operations by referring to the event-operation correspondence information stored in their own nodes, whereby the upper layer network can be automatically restructured.

### Advantageous Effects of Invention

According to the present invention, it is possible to restructure an upper layer network depending on a change in a network state, and to operate a multilayer network flexibly and cost-efficiently.

### BRIEF DESCRIPTION OF DRAWINGS

[FIG. 1]

FIG. 1 is a network diagram showing a configuration example of a multilayer network.

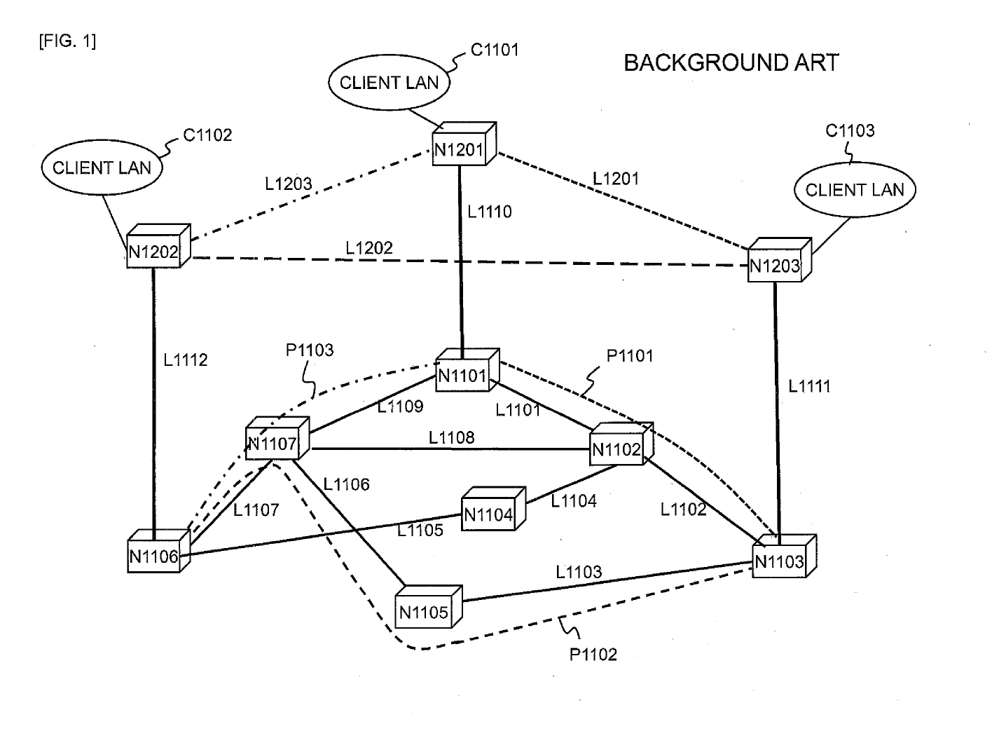

[FIG. 2]

FIG. 2 is a network diagram showing a configuration example of a VPN in a multilayer network at the time of normal operation, to describe a network restructuring method according to an exemplary embodiment of the present invention.

[FIG. 3]

FIG. 3 is a network diagram showing a configuration example of the VPN in the multilayer network at the time of occurrence of a failure, to describe the network restructuring method according to the present exemplary embodiment of the present invention.

[FIG. 4]

FIG. 4 is a block diagram showing module configurations of a node and a network design device in a network restructuring system according to an example of the present invention.

[FIG. 5]

FIG. 5 is a schematic diagram showing relevant portions of an event-operation database in the network restructuring system according to the present example.

[FIG. 6]

FIG. 6 is a sequence diagram showing an example of network restructuring operation according to the present example.

### DETAILED DESCRIPTION OF EMBODIMENTS

According to the present invention, operations that individual nodes should perform when restructuring an upper network in a multilayer network, as well as their sequence, are provided, whereby processing for setting a path at each layer can be cooperatively performed within the layer and between the layers, thus making it possible to realize flexible and cost-efficient restructuring at the upper layer. That is, an operation of each node and a condition for performing it are predetermined, whereby time consuming processing, for example, such as path calculation and bandwidth allocation calculation, is unnecessary after occurrence of a failure, making it possible to quickly recover the connectivity of a VPN, which is an upper-layer logical network, by using minimum network resources. Moreover, even if procedures for recovering from a plurality of failures at a plurality of upper layers are required, since they are processed in parallel, it is possible to greatly reduce time required to recover from the failures. Hereinafter, a structure and operation of a system according to an exemplary embodiment of the present invention will be described in detail.

### 1. Exemplary Embodiment

### 1.1) Structure

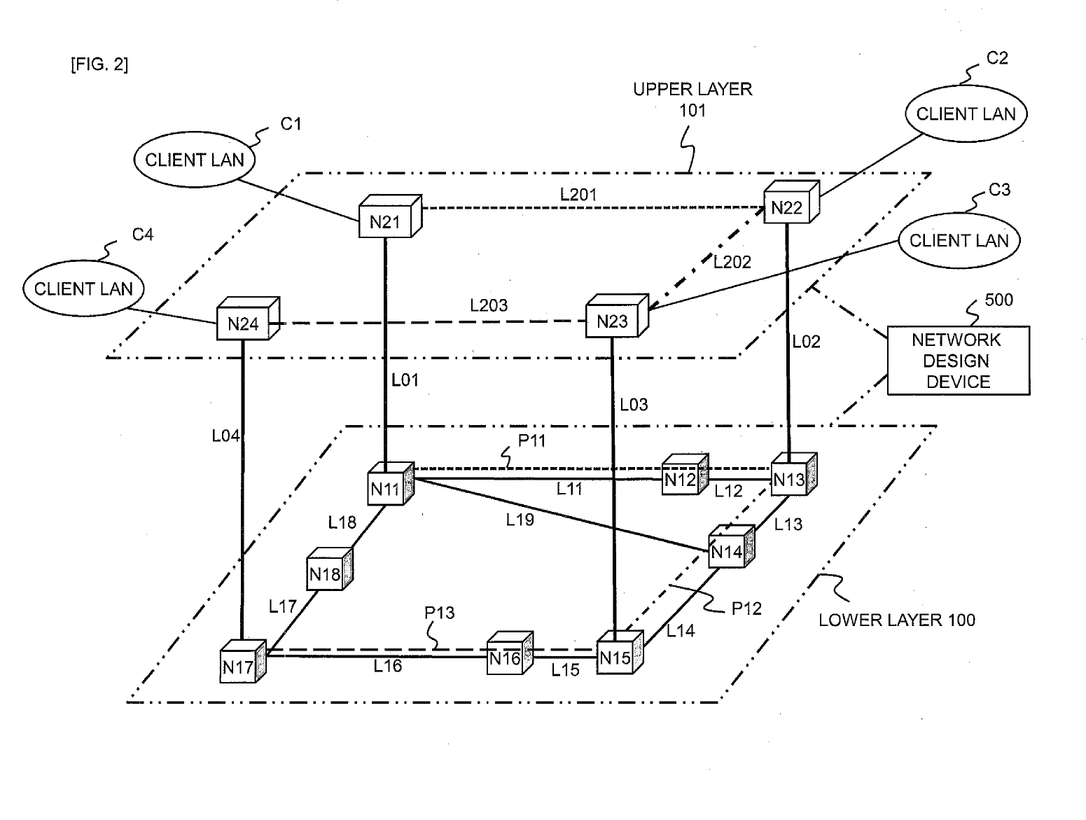

To avoid complexity of description, a description will be given using a multilayer network with two layers shown in FIG. 2 as an example, which, however, illustrates any two of layers of an arbitrary multilayer network.

Referring to FIG. 2, in a network at a lower layer 100, it is assumed that, as an example, nodes N11 to N18 are connected through links N11 to N18 in a ring topology, and further the nodes N11 and N14 are connected through a link L19. In this network at the lower layer 100, it is assumed that paths P11, P12, and P13 are set between the nodes N11 and N13, between the nodes N13 and N15, and between the nodes N15 and 17, respectively, and these three paths P11, P12, and P13 consist virtual links L201, L202, and L203 in a network at an upper layer 101, respectively. Accordingly, the network at the upper layer 101 is structured by nodes N21 and N22, N22 and N23, and N23 and N24 being connected through the virtual links L201, L202, and L203, respectively, and connectivity among the four nodes N21 to N24 is maintained. Here, it is assumed that the nodes N21 to N24 each are edge nodes of a VPN, and client networks (LANs) C1 to C4 are connected to them, respectively.

Moreover, the system according the present exemplary embodiment is provided with a network design device 500, which is connected to each node of the multilayer network via a control network. The network design device 500, as will be described later, assumes occurrence of various failures, communication quality deterioration, or the like (events), calculates methods for recovering from the individual failures as operational procedures for involved nodes, and thus generates event-operation correspondence information. The event-operation correspondence information thus generated is sent to each relevant one of the nodes and stored by each node.

### 1.2) Operation

When the network at the upper layer 101 is structured as described above, upon actual occurrence of a failure in the network at the lower layer 100, the system according to the present exemplary embodiment operates in a distributed manner so as to restructure the network at the upper layer 101.

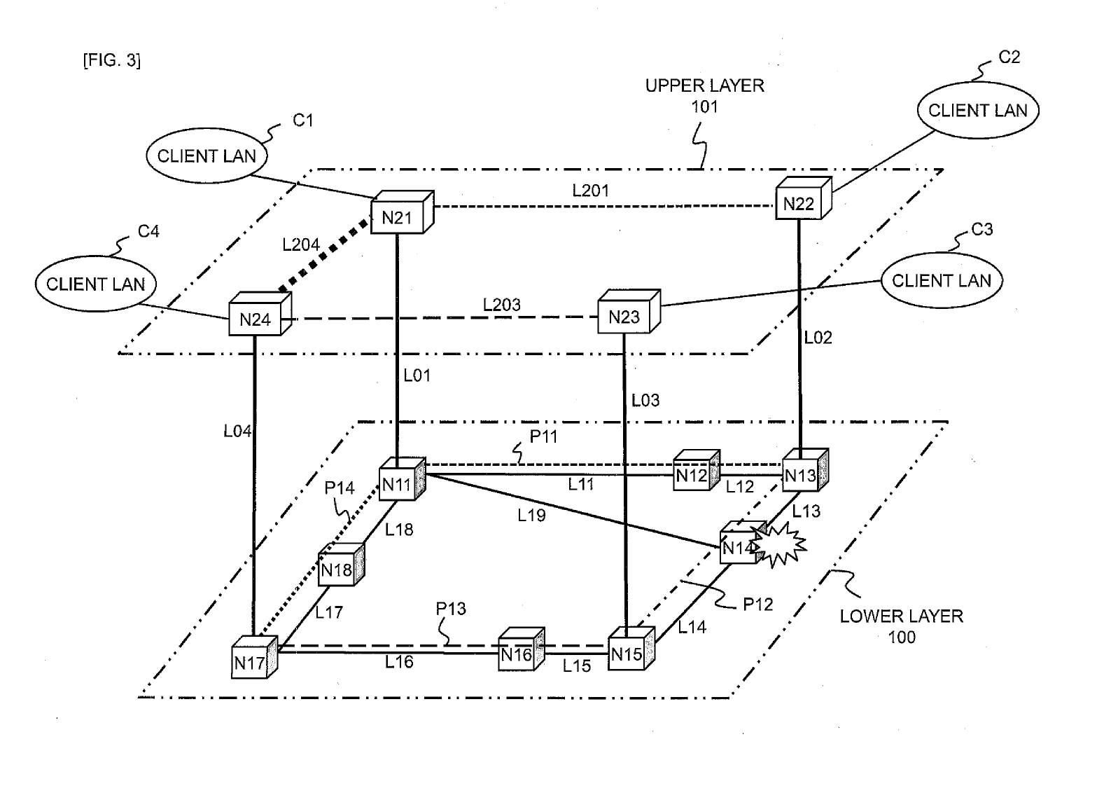

For example, it is assumed that a failure has actually occurred in the node N14, as shown in FIG. 3. The node 15, upon detecting occurrence of a failure in the path P12, refers to the event-operation correspondence information received from the network design device 500 to search for an operation corresponding to this event and, here, sends a notification of the occurrence of this event to the node N17.

The node N17, upon receiving an event occurrence notification message, refers to the event-operation correspondence information received from the network design device 500 to search for an operation corresponding to the event of receiving the event occurrence notification message, then, here, sets a path P14 between itself and the node N11, and notifies predetermined nodes (here, N21 and N24) at the upper layer 101 that this event has occurred.

The nodes N21 and N24, upon receiving an event occurrence notification message, refers to the event-operation correspondence information received from the network design device 500 to search for an operation corresponding to the event of receiving the event occurrence notification message, and, here, the nodes N21 and N24 detect a virtual link L204. Thus, in the network at the upper layer 101, the nodes N21 and N22, N23 and N24, and N24 and N21 are connected through the virtual links L201, L203, and L204, respectively, and connectivity among the four nodes N21 to N24 is recovered.

Note that although the virtual link L204 whose actual entity is the path P14 is set in FIGS. 2 and 3, this is not restrictive. It is also possible to design the event-operation correspondence information such as to set a virtual link between the nodes N21 and 23, or between the nodes N22 and N24. As to which virtual link is set, it is sufficient to determine a preferred one, in terms of cost efficiency, the distance of a path, the number of hops, propagation delay time, and the like. Accordingly, the operation of the system according to the present exemplary embodiment is not a search for a bypass path as described in PTLs mentioned earlier and others, but is a series of node operations to maintain network connectivity at the upper layer 101.

Moreover, since an event occurrence notification message can be notified to all involved nodes at the upper layer, processing for recovering from a failure can be performed in parallel at a plurality of layers, independently of the number of layers and the number of virtual links to recover.

### 1.3) Effects

As described above, according to the present exemplary embodiment, operations that individual nodes should perform and their sequence are stored previously by the individual nodes, in the form of event-operation correspondence information, so that when a failure occurs, processing for setting a path at each layer will be cooperatively performed within the layer and between the layers. Thereby, it can be achieved to flexibly and cost-efficiently maintain connectivity at an upper layer. Moreover, time consuming processing, such as path calculation and bandwidth allocation calculation, is unnecessary after occurrence of a failure, making it possible to quickly recover the connectivity of a VPN, which is an upper-layer logical network, by using minimum network resources. Moreover, even if procedures for recovering from a plurality of failures at a plurality of upper layers are required, since they are processed in parallel, it is possible to greatly reduce time required to recover from the failures.

### 2. Example

### 2.1) Network Restructuring System

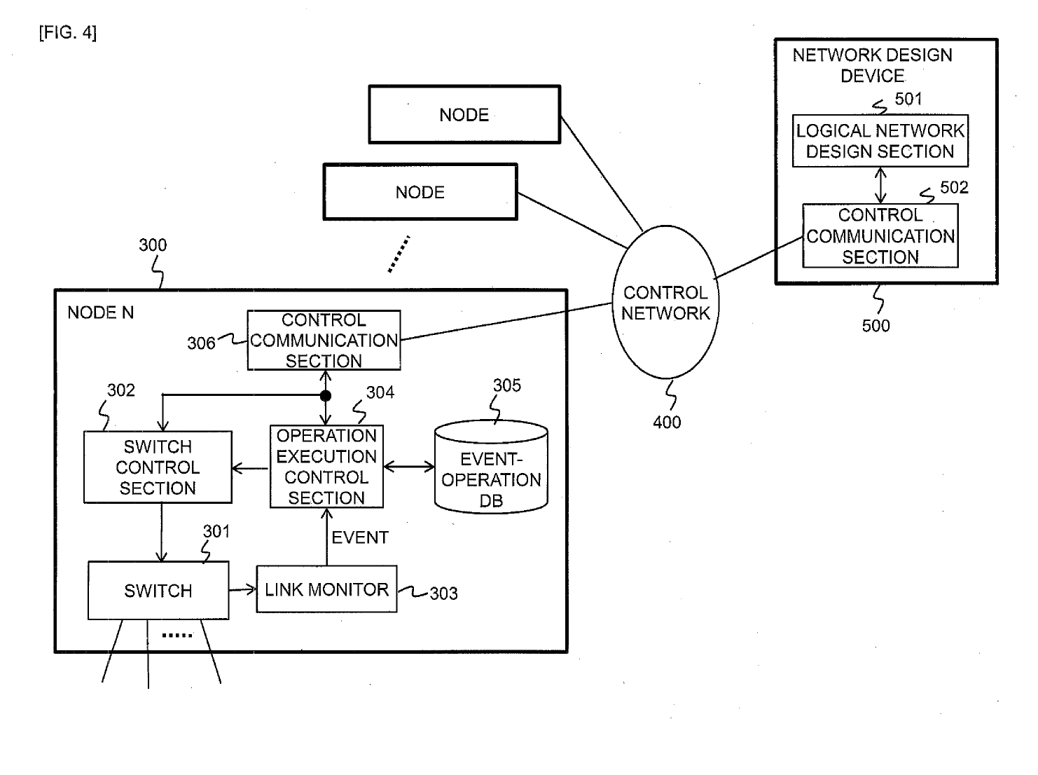

Referring to FIG. 4, a network restructuring system according to an example of the present invention includes a plurality of nodes 300 forming a multilayer network, a control network 400, and the above-described network design device 500. The plurality of nodes 300 are connected to the network design device 500 via the control network 400.

Each node 300 includes a switch 301 that switches communication traffics, a switch control section 302 that controls the switch 301, and a link monitor 303 that monitors a state of a communication link L connecting to a neighboring node, as well as a function enabling network restructuring operation according to the present example. Specifically, each node 300 further includes an operation execution control section 304 that executes an operation according to an event, an event-operation database 305 that retrievably stores event-operation correspondence information, and a control communication section 306 for communicating with other nodes and the network design device 500. The control communication section 306 is connected to the control network 400 through a physical or logical line and sends/receives messages to/from control communication sections of other nodes.

The switch control section 302 can control the switch 301 to switch data traffic transfer directions. The link monitor 303 monitors a state of each link connected to the switch 301, detects a disconnection and the like of a link, and notifies it as an event to the operation execution control section 304.

Upon occurrence of an event notified by another node through the control communication section 306 or detected by the link monitor 303, the operation execution control section 304, as will be described later, refers to the event-operation database 305, determines an operation corresponding to the input event, and executes the operation.

The event-operation correspondence information stored in the event-operation database 305 is generated by the network design device 500. The network design device 500 basically includes a logical network design section 501 and a control communication section 502. The logical network design section 501, as will be described later, calculates methods for recovering from failures responding to assumed events such as various failures or communication quality deterioration, as operational procedures for involved nodes, thereby generating the event-operation correspondence information. The generated event-operation correspondence information is distributed from the control communication section 502 to the respective involved nodes via the control network 400.

Note that a function equivalent to the logical network design section 501 of the network design device 500 also can be implemented by executing a program stored in a memory (not shown) on a program-controlled processor such as a CPU (central processing unit) or the like. Similarly, a function equivalent to the operation execution control section 304 of each node 300 also can be implemented by executing a program stored in a memory (not shown) on a program-controlled processer of the node.

Moreover, the control network 400 can share part or all of its physical transmission devices and media with the multilayer network formed with the plurality of nodes 300. Furthermore, the network design device 500 can be connected to each node via the control network 400 but is not limited to the one shown in FIG. 4, and also can be included as a module within the nodes 300.

Next, a description will be given of the event-operation correspondence information stored in the event-operation database 305.

### 2.2) Event-Operation Correspondence Information

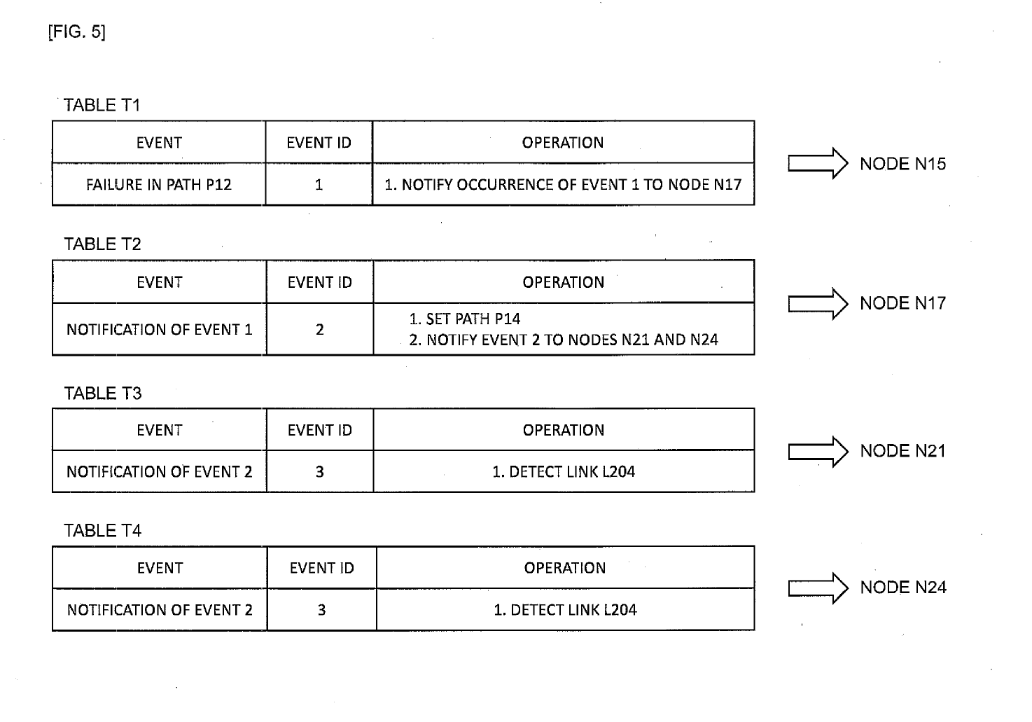

As shown in FIG. 5, the event-operation correspondence information stored in the event-operation database 305 of each node is a combination of an event and an operation and includes an event, an event ID (identifier), and an operation corresponding to this event. Hereinafter, a method for generating the event-operation correspondence information will be described, using the case shown in FIG. 3 as an example in which a failure has occurred in the path P12 due to a fault of the node N14.

First, the logical network design section 501 of the network design device 500 calculates a method for recovering from a failure if it occurs, for each of various failures. For example, it is assumed that the path P12 is disconnected due to a fault of the node N14 and as a result the virtual link L202 at the upper layer 101 is disconnected. In this case, to recover the connectivity of this upper layer network, it is necessary to set a virtual link between any one of node pairs of the nodes N21 and N23, the nodes N21 and N24, the nodes N22 and N23, and the nodes N22 and N24.

To set the respective virtual links, at the lower layer 100, a path with four (4) hops must be set between the nodes N21 and N23, a path with two (2) hops between the nodes N21 and N24, a path with six (6) hops between the nodes N22 and N23, and a path with four (4) hops between the nodes N22 and N24. Here, it is assumed that in view of cost efficiency, the virtual link L204 is set between the nodes N21 and N24, with the smallest number of hops that must be set at the lower layer 100, as shown in FIG. 3. Note that for criteria to determine a virtual link to add for recovery from a failure, although cost efficiency is used in this example, any other parameter can be used, such as the distance of a path, the number of hops, or propagation delay time.

Subsequently, the logical network design section 501 calculates procedures required to add the virtual link L204. To use L204 as a link, the nodes N21 and N24 at the ends of it need to detect L204 as a link. For the nodes N21 and N24 to detect the link L204, the path P14 needs to have been set. Further, to set the path P14, signaling is performed between the nodes N17 and N11. Since the node 17 has no neighboring relationship with the node N14 where a failure has occurred, for the node N17 (or node N11) to start signaling after a failure has occurred in the node N14, the node N15 (or node N13) needs to send a notification message to the node N17.

By reversely following the procedures required to set the virtual link L204 in this manner, it becomes clear which node needs to perform what operation at what timing, whereby tables of correspondence between an event and an operation as shown in FIG. 5 (tables T1 to T4) can be created. The logical network design section 501 distributes the created tables T1 to T4 to the nodes N15, N17, N21, and N24, respectively, via the control network 400. The nodes N15, N17, N21, and N24 that have received the respective tables T1 to T4 store the tables in their own event-operation databases 305. Similarly thereafter, event-operation correspondence information in case of failures occurring in the other paths P11 and P13 is also distributed to involved nodes and stored in the event-operation database 305 of each node.

### 2.4) Upper-Layer Network Restructuring Sequence

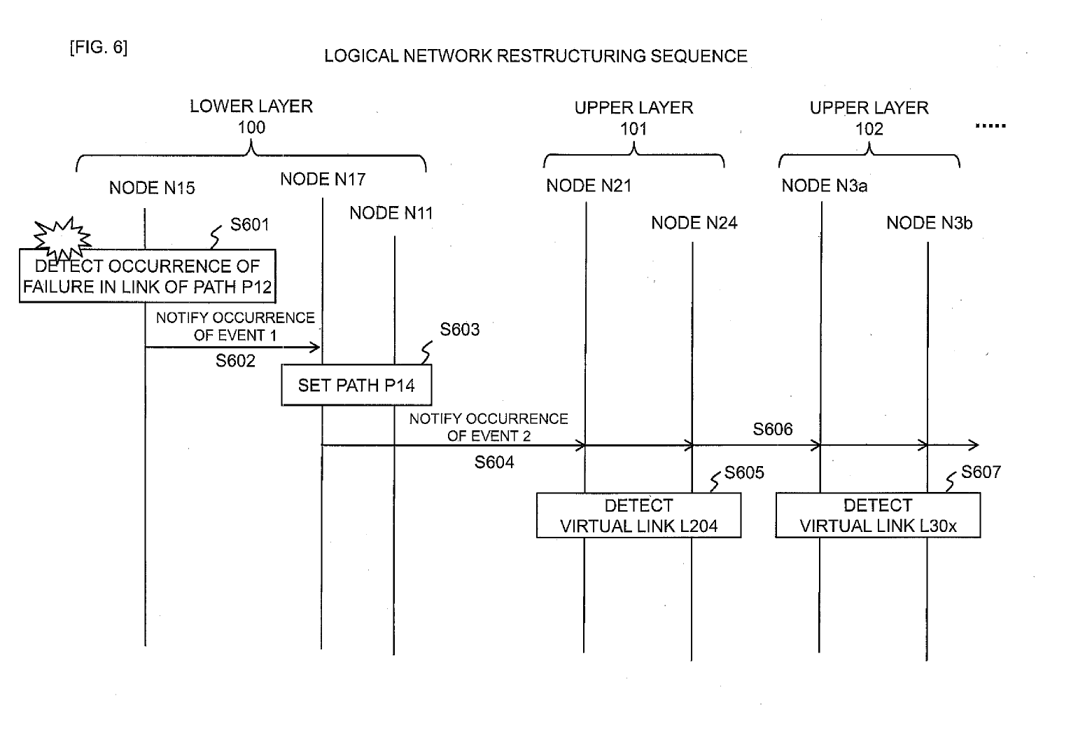

A description will be given specifically, with reference to FIG. 6, of procedures for connectivity at the upper layer to be maintained when a failure has actually occurred in the node N14 at the lower layer 100 (here, a physical layer) in the state where the tables T1 to T4 shown in FIG. 5 are stored in the nodes N15, N17, N21, and N14, respectively.

Referring to FIG. 6, when a failure has actually occurred in the node N14, the node N15 using its own link monitor 303 detects that a failure has occurred in the path P12 (Step S601). The link monitor 303 notifies the operation execution control section 302 that a failure has occurred in the path P12. The operation execution control section 302 of the node N15 refers to the table T1 (FIG. 5) stored in its own event-operation database 305, detects that the notification from the link monitor 303 corresponds to an event 1 (ID=1), and performs an operation corresponding to the event 1, that is, sends a notification of occurrence of the event 1 to the node N17 (Step S602). This notification message is sent to the node N17 via the control communication section 301 and the control network 400. Note that to release the band used by the path P12, it is also possible to add an elimination of the path P12 to the operation in the table T1.

The control communication section 301 of the node N17, upon receiving the notification message of occurrence of the event 1, notifies it to the operation execution control section 302 of the node N17. The operation execution control section 302 of the node N17 refers to the table T2 (FIG. 5) stored in its own event-operation database 305, detects that the notification corresponds to an event 2 (ID=2), and performs an operation corresponding to the event 2, that is, sets the path P14 between its own node and the node N11 by signaling (Step S603). Then, a notification indicating that the event 2 has occurred is sent from the control communication section 301 to the nodes N21 and N24 at the upper layer via the control network 400 (Step S604).

When the node N21 has received the notification message of occurrence of the event 2 through the control communication section 301, the operation execution control section 302 refers to the table T3 (FIG. 5) stored in its own event-operation database 305, detects that the notification corresponds to an event 3, and performs an operation corresponding to the event 3, that it, detects L204 as a link. Similarly, the node N24 detects the same link L204, whereby as a result, network connectivity at the upper layer 101 is recovered (Step S605).

Note that if an upper layer 102 other than the upper layer 101 exists, in which a virtual link affected by the failure in the path P14 exists, the operation execution control section 302 of the node N17, as in the above-described steps, sends a notification indicating that the event 2 has occurred from the control communication section 301 to nodes N3a and N3b at the upper layer 102 via the control network 400 (Step S606), and the nodes N3a and N3b detect a link L30x, whereby network connectivity at the upper layer 102 is recovered (Step S607). Even if three or more upper layers exist, network connectivity can be maintained through similar steps.

As described above, even if a virtual link is disconnected at each upper layer due to a failure in the path P12, a plurality of nodes sequentially execute their respective predetermined operations in accordance with the event-operation correspondence information, whereby a new virtual link is generated, and connectivity at the upper layers can be maintained.

### 3. Modified Examples

As mentioned in FIG. 6, the present invention is not limited to networks with two layers, but can be applied to networks with three or more layers. Moreover, the number of nodes and the number of links at each layer can differ from the numbers used in the above descriptions. Although the number of upper layer networks is one in the above description, a plurality of upper layer networks can exist.

Moreover, an event starting the network restructuring processing is not necessarily a detection of a network failure, but can be a detection of communication quality deterioration such as an excessively loaded state of a link. Furthermore, according to the present example, an event starting the network restructuring processing can be intentionally caused by the network design device 500 or another network management device sending a control message.

### 4. Additional Statements

Part or the whole of the above-described exemplary embodiment also can be stated as in, but is not limited to, the following additional statements.

### (Additional Statement 1)

A network restructuring system in a multilayer network including multiple layers, characterized in that

each node at each layer includes: storage means that stores event-operation correspondence information indicating correspondence between an event and an operation; and operation execution control means that, upon occurrence of an event, refers to the event-operation correspondence information and executes an operation corresponding to the event,

wherein the operation is at least one of sending a message indicating the occurrence of the event to a specified node, setting a path that bases a link in at least one upper layer network, and a combination thereof, and

wherein with a node that has detected occurrence of a predetermined event serving as a start point, nodes sequentially specified execute operations by referring to the event-operation correspondence information stored in their own nodes, whereby the upper layer network is automatically restructured.

### (Additional Statement 2)

The network restructuring system as set forth in additional statement 1, characterized in that the event-operation correspondence information, which includes an operation to be executed by each of a chain of the nodes between the node serving as the start point and a node setting the path and an event conditioning the operation to be executed, is provided previously from a control network.

### (Additional Statement 3)

The network restructuring system set forth in additional statement 1 or 2, characterized in that the event is a change in a state of a link between each node and its neighboring node which is monitored by the node.

### (Additional Statement 4)

The network restructuring system as set forth in any one of additional statements 1 to 3, characterized in that the node serving as the start point, the node setting the path, and the nodes between them belong to a physical network, and the upper layer network is a virtual network built upon the physical network.

### (Additional Statement 5)

A node device included in a multilayer network that includes multiple layers, characterized by comprising:

control communication means for communicating control information with another node via a control network;

link monitoring means that monitors a change in a state of a link used to transmit data;

an event-operation database that retrievably stores, as the event-operation correspondence information, a combination of an event received from the another node or detected by the link monitoring means and an operation corresponding to the event; and

operation execution control means that, upon occurrence of the event, refers to the event-operation correspondence information and executes the operation corresponding to the event that has occurred,

wherein the operation is at least one of sending a message indicating the occurrence of the event to a specified node, setting a path that bases a link in at least one upper layer network, and a combination thereof.

### (Additional Statement 6)

The node device as set forth in additional statement 5, characterized in that the event-operation correspondence information is received from the control network and stored in the event-operation database previously.

### (Additional Statement 7)

A network design device that designs an upper layer network of a multilayer network including multiple layers, characterized by comprising:

design means that calculates operational procedure including setting a path in a lower layer network required to establish a link in the upper layer network and sending/receiving a notification message, and generates event-operation correspondence information indicating correspondence between an event and an operation for each of nodes involved in the procedure; and control communication means for sending the event-operation correspondence information to each relevant node,

wherein the operation is at least one of sending a message indicating occurrence of an event to a specified node, setting a path that bases a link in at least one upper layer network, and a combination thereof, and

wherein with a node that has detected occurrence of a predetermined event serving as a start point, nodes sequentially specified execute operations by referring to the event-operation correspondence information stored in their own nodes, whereby the upper layer network can be automatically restructured.

### (Additional Statement 8)

The network design device as set forth in additional statement 7, characterized in that the event is a change in a state of a link between each node and its neighboring node which is monitored by the node.

(Additional statement 9)

The network design device as set forth in additional statement 7 or 8, characterized in that the node serving as the start point, the node setting the path, and the nodes between them belong to a physical network, and the upper layer network is a virtual network built upon the physical network.

(Additional statement 10)

A network restructuring method in a multilayer network including multiple layers, characterized in that

each node at each layer

stores event-operation correspondence information indicating correspondence between an event and an operation that is at least one of sending a message indicating occurrence of an event to a specified node, setting a path that bases a link in at least one upper layer network, and a combination thereof, and upon occurrence of an event, refers to the event-operation correspondence information and executes an operation corresponding to the event that has occurred,

wherein with a node that has detected occurrence of a predetermined event serving as a start point, nodes sequentially specified execute operations by referring to the event-operation correspondence information stored in their own nodes, whereby the upper layer network is automatically restructured.

### (Additional Statement 11)

The network restructuring method as set forth in additional statement 10, characterized in that the event-operation correspondence information, which includes an operation to be executed by each of a chain of the nodes between the node serving as the start point and a node setting the path and an event conditioning the operation to be executed, is provided previously from a control network.

### (Additional Statement 12)

The network restructuring method as set forth in additional statement 10 or 11, characterized in that the event is a change in a state of a link between each node and its neighboring node which is monitored by the node.

### (Additional Statement 13)

The network restructuring method as set forth in any one of additional statements 10 to 12, characterized in that the node serving as the start point, the node setting the path, and the nodes between them belong to a physical network, and the upper layer network is a virtual network built upon the physical network.

### (Additional Statement 14)

A program causing a program-controlled processor of a node device to function, wherein the node device included in a multilayer network that includes multiple layers, comprises: control communication means for communicating control information with another node via a control network; and link monitoring means that monitors a change in a state of a link used to transmit data, characterized by causing the program-controlled processor to function so as to:

have an event-operation database retrievably store, as the event-operation correspondence information, a combination of an event received from the another node or detected by the link monitoring means and an operation corresponding to the event; and

upon occurrence of the event, refer to the event-operation correspondence information and execute the operation corresponding to the event that has occurred,

wherein the operation is at least one of sending a message indicating the occurrence of the event to a specified node, setting a path that bases a link in at least one upper layer network, and a combination thereof.

### (Additional Statement 15)

A program causing a program-controlled processor of a network design device to function, wherein the network design device designs an upper layer network of a multilayer network including multiple layers, characterized by causing the program-controlled processor to function so as to:

calculate an operational procedure including setting a path in a lower layer network required to establish a link in the upper layer network and sending/receiving a notification message, and generate event-operation correspondence information indicating correspondence between an event and an operation for each of nodes involved in the procedure; and

send the event-operation correspondence information to each relevant node,

wherein the operation is at least one of sending a message indicating occurrence of an event to a specified node, setting a path that bases a link in at least one upper layer network, and a combination thereof, and

wherein with a node that has detected occurrence of a predetermined event serving as a start point, nodes sequentially specified execute operations by referring to the event-operation correspondence information stored in their own nodes, whereby the upper layer network can be automatically restructured.

### INDUSTRIAL APPLICABILITY

The present invention is applicable to multilayer networks in which an upper layer network can be restructured.

### REFERENCE SIGNS LIST

100 Lower layer
101 Upper layer
300 Node
301 Switch
302 Switch control section
303 Link monitor
304 Operation execution control section
305 Event-operation database
306 Control communication section
400 Control network
500 Network design device
501 Logical network design section
502 Control communication section
L11-L19 Links at lower layer
L201-L204 Virtual links
N11-N18 Nodes at lower layer
N21-N24 Nodes at upper layer
P11-P13 Paths

What is claimed is:

1. A network restructuring system in a multilayer network including multiple layers, wherein
each node at each layer comprises:
a storage section that stores event-operation correspondence information indicating correspondence between an event and an operation; and
an operation execution controller that, upon occurrence of an event, refers to the event-operation correspondence information and executes an operation corresponding to the event,
wherein the operation is at least one of a sending operation of sending a message indicating the occurrence of the event to a specified node and a setting operation of setting a path that bases a link in at least one upper layer network, and
wherein with a node that has detected occurrence of a predetermined event serving as a start point, nodes sequentially specified execute operations by referring to the event-operation correspondence information stored in their own nodes, whereby the upper layer network is automatically restructured.

2. The network restructuring system according to claim 1, wherein the event-operation correspondence information is provided previously from a control network, wherein the event-operation correspondence information includes an operation to be executed by each of a chain of the nodes between the node serving as the start point and a node setting the path and an event conditioning the operation to be executed.

3. The network restructuring system according to claim 1, wherein the event is a change in a state of a link or path between two nodes, which is monitored by both or either of the nodes.

4. The network restructuring system according to claim 1, wherein the node serving as the start point, the node setting the path, and the nodes between them belong to a physical network, and the upper layer network is a virtual network built upon the physical network.

5. A node device included in a multilayer network that includes multiple layers, comprising:
a control communication section for communicating control information with another node via a control network;
a link monitor that monitors a change in a states of a links and paths terminated at the node and used to transmit data;
an event-operation database that retrievably stores, as event-operation correspondence information, a combination of an event received from the another node or detected by the link monitoring means and an operation corresponding to the event; and
an operation execution controller that, upon occurrence of the event, refers to the event-operation correspondence information and executes the operation corresponding to the event that has occurred,
wherein the operation is at least one of a sending operation of sending a message indicating the occurrence of the event to a specified node and a setting operation of setting a path that bases a link in at least one upper layer network.

6. The network restructuring system according to claim 1, further comprising a network design device that designs an upper layer network of a multilayer network including multiple layers, wherein the network design device comprises:
a design section that calculates an operational procedure including setting a path in a lower layer network required to establish a link in the upper layer network and sending/receiving a notification message, and generates event-operation correspondence information indicating correspondence between an event and an operation for each of nodes involved in the operational procedure; and
a control communication section for sending the event-operation correspondence information to each relevant node,
a sending operation of and a setting operation of.

7. A network restructuring method in a multilayer network including multiple layers, comprising:
at each node of each layer
storing event-operation correspondence information indicating correspondence between an event and an operation that is at least one of a sending operation of sending a message indicating the occurrence of the event to a specified node and a setting operation of setting a path that bases a link in at least one upper layer network, and
upon occurrence of an event, referring to the event-operation correspondence information and executing an operation corresponding to the event that has occurred,
wherein with a node that has detected occurrence of a predetermined event serving as a start point, nodes sequentially specified execute operations by referring to the event-operation correspondence information stored in their own nodes, whereby the upper layer network is automatically restructured.

8. The network restructuring method according to claim 7, wherein the event-operation correspondence information is provided previously from a control network, wherein the event-operation correspondence information includes an operation to be executed by each of a chain of the nodes between the node serving as the start point and a node setting the path and an event conditioning the operation to be executed.

9. The network restructuring method according to claim 7 wherein the event is a change in a state of a link or path between two nodes which is monitored by both or either of the nodes.

10. The network restructuring method according to any one of claim 7, wherein the node serving as the start point, the node setting the path, and the nodes between them belong to a physical network, and the upper layer network is a virtual network built upon the physical network.

11. The node device according to claim 5, wherein the event-operation correspondence information stored in the event-operation database is previously received from the control network.

12. The network restructuring system according to claim 6, wherein the event is a change in a state of a link or path between two nodes, which is monitored by both or either of the nodes.

13. The network restructuring system according to claim 6, wherein the event is intentionally caused by a control message sent by the network design device or another network management device.

14. The network restructuring system according to claim 6, wherein the node serving as the start point, the node setting the path, and the nodes between them belong to a physical network, and the upper layer network is a virtual network built upon the physical network.
